(19) United States
(12) Patent Application Publication
(10) Pub. No.: US 2004/0117201 A1
(43) Pub. Date: Jun. 17, 2004

(54) Mapping apparatus and methods

(76) Inventor: Christopher William Preist, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/473,607

(22) PCT Filed: Apr. 11, 2002
(86) PCT No.: PCT/GB02/01703

(30) Foreign Application Priority Data
Apr. 11, 2001 (GB) 0109075.2
Jul. 27, 2001 (GB) 0118457.1

(51) Int. Cl. G06F 17/60

(52) U.S. Cl. 705/1

(57) ABSTRACT

A multi-dimensional preference map may be used to assist an agent such as a negotiating agent to make decisions and recommendations based on a users preference embodied in the map. The generation of a multi-dimensional map may be created using partial information in the form of constraining rules which operate over a range of one or more of the dimensions of the preference map.

In the field of artificial intelligence (AI), there is a need to record users' preferences in order for the AI apparatus to make decisions in the absence of the user. Increasingly, it is necessary to record user preferences in terms of many parameters. For example, in the field of object recognition, it may be desired to use to choose an object which it is know the user will find attractive. Thus, it may be necessary to record the user's preferences concerning colour, shape, size, texture, smell and/or weight. In another example, it may be necessary in an automated negotiating scenario for a negotiating agent to record a contracting party's preferences concerning delivery time, quality, cost and quantity of product or services.

Typically, these preferences are stored in a data structure which conceptually may be considered as a surface. Such a data structure is sometimes termed a preference map or a bumpy utility surface. Broadly speaking, the preference map is used to take a value specified in co-ordinate terms using the parameters which it is desired to record in the data structure and read off a value on a master axis of the preference map (typically termed a “utility” score from parallels with economic theory) and return this as a utility score or desirability value for the proposal. The proposal in the case of the object attractiveness example above would typically be an analysed image of an object and in the case of the negotiation example would be a proposed contract.

The use of such a preference map can be shown to be effective. However, the effectiveness of the preference map is determined entirely by the accuracy with which the “shape” of the surface is constructed. The accuracy of the construction, in turn, depends on user input. The conventional approach is to have a user complete a questionnaire with carefully selected questions. The questions are selected so that the user responses provide discrete points within the multi-dimensional space formed by the parameters which are to be embodied in the preference status structure. The surface may then be interpolated between these discrete points.

This approach, however, becomes onerous if many parameters are to be embodied in the preference map. This is because the volume of questions which must be asked of the user increases dramatically with an increase in the numbers of parameters. Thus for simple preference maps (which may for example simply map cost against utility) a questionnaire may only require three or four questions. The number of questions will typically increase exponentially with an increase in parameters (and therefore of dimensions for the map). Thus a four or five parameter preference map may require many hundreds of questions to be answered. If these questions are answered inaccurately then the AI agent will make incorrect decisions on behalf of the user since it will not have a correct representation of the user's preferences.

Thus if agents are to operate in complex (i.e. multi-dimensional) situations, then it will be necessary to overcome the problem of initial user data input to establish the decision making background upon which the agent should operate.

In a first aspect of the invention there is provided a multi-dimensional surface comprising at least one predetermined rule each arranged to specify a relationship between at least two of the dimensions over a predetermined range of each dimension, the rules thereby defining areas of the surface and the remainder of the surface being formed as an interpolated surface between the rule-defined areas.

By defining the surface using rules rather than point co-ordinates, it is possible for a user to specify constraints of his or her preferences rather than single examples. Thus, for example, in a negotiating scenario, a user may specify that he or she will always wish to pay less than $2 per article. In terms of the utility map for cost, it is therefore possible to envisage a surface as a planer surface of unit value for all costs less than $2 and a planer surface of zero value for all costs above $2. Although this is a simplistic example, it will be seen that a large area of the surface map can thereby be defined with an answer to a single question. In the prior art, an approximation to this may have been obtained by asking the user whether the cost of the articles would be acceptable at 50 c, $1, $1.50, $2 and $2.50. This would have provided discrete points on the surface which once interpolated would have approximated the surface produced by the rules specifying dimensions over at least a predetermined range of at least one of the dimensions. However, in the prior art, five questions would have been required.

In a second aspect, the invention provides a method of mapping a multi-dimensional value to a scalar value comprising defining a surface using one or more rules which define the surface of a space in a multidimensional space, each rule defining a relationship over a range of at least one of the dimensions determining the position of the multidimensional value on the said surface by mapping the value onto the surface using the received co-ordinates of the multidimensional and returning the a scalar value which corresponds to the position of the mapped multidimensional value along a master axis of the multidimensional space.

Thus, using the surface of the first aspect, it is possible to map a multi-dimensional value to a scalar value. In this way, the required processing of a particular problem by an AI agent may be reduced by reducing the complexity of the value to one dimension.

In a third aspect, therefore there is provided a method of mapping a scalar value to a multi-dimensional value comprising defining a surface using one or more rules which define the surface of a space in a multidimensional space, each rule defining a relationship over a range of at least one of the dimensions, determining the position of the scalar value along a master axis of the multidimensional space, determining the co-ordinates of the position on the said surface which corresponds to the said position along the master axis and outputting the co-ordinates as a multidimensional mapping of the scalar value.

In this way, the output of a decision making agent may be unpacked from a single scalar value back to a multi-dimensional format. It will be appreciated that in the unpacking phase, there may be several portions of the surface which correspond to a particular value on the master axis. In a negotiating scenario, this may mean, for example, that there are several acceptable proposals which have the same utility for that particular negotiating party. Thus it may be that in the method of the third aspect, the mapping of a scalar value actually produces a plurality of multi-dimensional values.

In accordance with a fourth aspect, there is provided mapping apparatus having a multi-dimensional input, a scalar output and a rule database, the rule database being arranged to contain a rule which defines a relationship between a master dimension and at least one other dimension in a multidimensional space, the relationship being defined over a range of at least one of the said dimensions, whereby the rule defines a surface in the multidimensional space, the mapping apparatus being arranged to receive a multidimensional value via the vector input specified in terms of co-ordinate values of any of the dimensions of the rule in the rule database except the master dimension, the mapping apparatus being further arranged to map the received multidimensional value to a single value by determining where the multidimensional value lies on the surface defined by the rule, and determining the co-ordinate of this position along the axis of the master dimension, the scalar output being arranged to output the single value determined thereby.

In a further aspect, there is provided inverse mapping apparatus having a multi-dimensional output, a scalar input and a rule database, the rule database being arranged to contain a rule which defines a relationship between a master dimension and at least one other dimension in a multidimensional space, the relationship being defined over a range of at least one of the said dimensions, whereby the rule defines a surface in the multidimensional space, the mapping apparatus being arranged to receive a single-dimensional value via the scalar input, the mapping apparatus being further arranged to map the single-dimensional value to a multidimensional value specified in terms of co-ordinate values of any of the dimensions of the rule in the rule database except the master dimension by determining where the single-dimensional value lies along the axis of the master dimension and determining the co-ordinates of the surface which corresponds to that position on the master dimension, the multi-dimensional output being arranged to output the multidimensional value determined thereby.

Embodiments of the invention will now be described by way of example with reference to the drawings in which:-

FIG. 1 is a plot of a utility function;

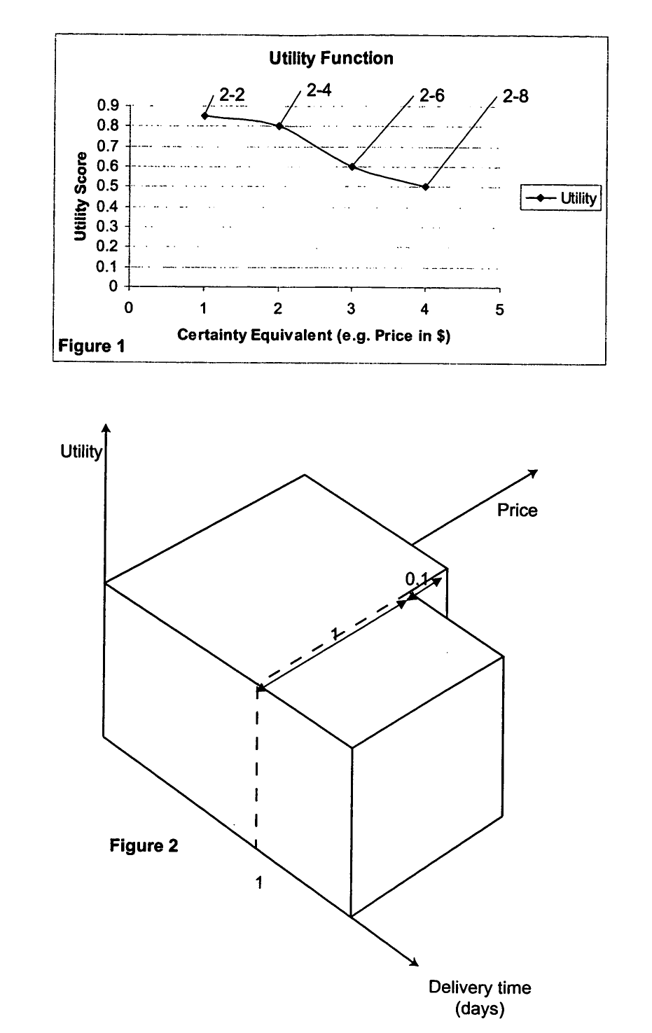

FIG. 2 is a perspective view of a constrained rule;

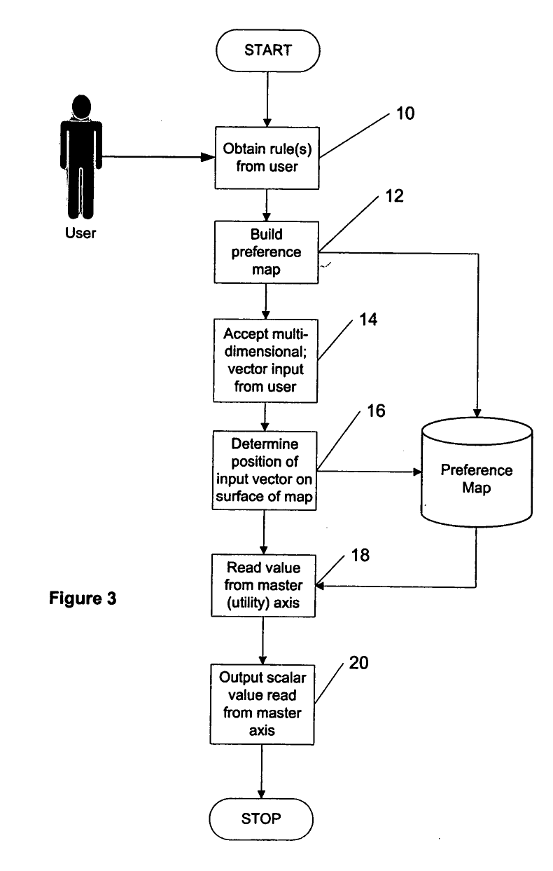

FIG. 3 is a flowchart of a mapper in accordance with the invention; and

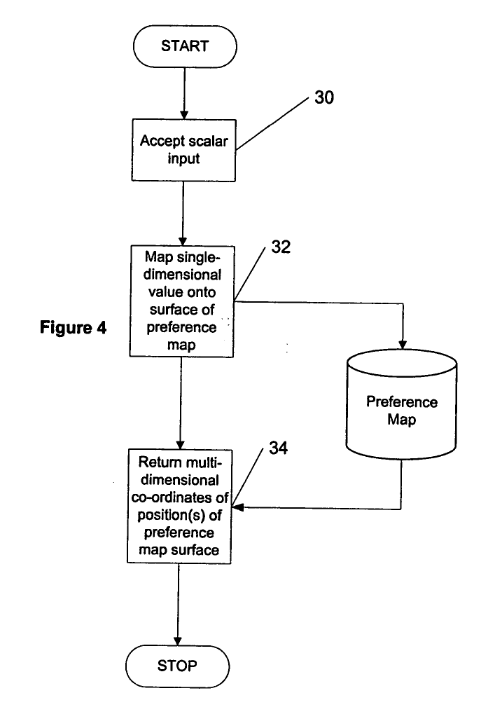

FIG. 4 is a flowchart of an inverse mapper in accordance with the invention.

A preferred embodiment of the invention is described below which is used in connection with an automated negotiating agent. Thus the example below is concerned with the recordal of a negotiating party's negotiating preferences. It will be appreciated that the principles set out below apply equally to any situation in which an artificial intelligence (AI) agent needs to record preferences over a space which is defined by many parameters.

Negotiating agents have been produced which function over a two dimensional space. For example, and with reference to FIG. 1, a utility function may be defined for price. Thus with the function shown schematically in FIG. 1, It will be noted that a party wishing to buy a product places greater utility on lower price. The function typically is discerned by analysing answers to a questionnaire which specifies points 2-2, 2-4, 2-6 and 2-8 in the space defined by the dimensions utility and price, and then interpolating between the points (for example using linear regression analysis) to derive a generic function.

As discussed above, this approach is adequate in situations where very few dimensions are to be processed.

However, in the embodiment described below, the utility of any particular negotiating proposal (specified in many dimensions) is determined using a multi-dimensional surface or preference map. Since the map has more than one dimension (in addition to the utility dimension) the creation of the map using prior art questionnaires is onerous.

Thus in the preferred embodiment, the map is built up using a series of constraints. As discussed below, these constraints may also have temporal properties.

A typical constraint might be “CURRENTLY, I am prepared to pay an extra 10% for next day delivery”. This constraint is illustrated schematically in FIG. 2. It will be seen that this constraint defines a map which has utility 1 for a price of 110% up to a delivery time of 1 day. Beyond a delivery time of 1 day, the utility of an extra 10% price drops to zero. Thus with a single constraining rule which deals with the full range of the delivery time dimension, the utility of particular delivery times has been specified. The prior art approach would have required a series of questions specifying different prices and delivery times in order to arrive at the same generalised preference map.

Thus in the invention, a single question suffices where many would be required in the prior art.

The preference map may be refined, for example by adding an additional rule which specifies that “CURRENTLY, the maximum I am prepared to pay per component is $2”. This therefore puts another bound on the cost dimension (unbounded in all other dimensions) which further refines the “shape” of the preference map.

Further rules may be “GENERALLY, I will not accept components with a failure rate greater rate than 0.0001”. This specifies an additional dimension of failure rate with a surface at 0.0001 at which the utility falls to zero.

A yet further rule may be “I ALWAYS prefer to pay X than Y for the same contract if X is less than Y”.

Thus with only four rules, a complex preference map in four dimensions (utility, cost or price, failure rate and delivery time) has been created.

Furthermore, it will be noted that the terms “ALWAYS”, “GENERALLY”, and “CURRENTLY” have been used above.

These terms are used to denote a priority hierarchy and temporal constraints on the rules. An “ALWAYS” rule has priority over all other rules. A “CURRENT” rule decays over time so that if the rule is a recent rule then it overrides a “GENERALLY” rule. As time passes, a “GENERALLY” rule has priority over an old “CURRENTLY” rule.

Thus, considering the example above, the customer is keen at the moment, to have products within a day. For rapid delivery, the customer is currently prepared to pay an additional 10%. However, in time, the urgency will have passed and the customer may revert to its normal pricing practices.

Thus it will be appreciated that parts of the preference map using these rules may be reused. Thus the GENERALLY and ALWAYS rules stand over time whereas the “CURRENTLY” rules have a limited lifetime. In this way, a negotiating party need not regenerate the whole of a preference map prior to a new negotiation. It may simply update its existing map using a series of “currently” rules. Thus not only does the preference map of the present invention reduce the burden of initially specifying the preference map by allowing partial information to be provided (i.e. not requiring information across all dimensions of the domain) but also avoids the need to repeat information which is consistent across all uses of the AI agent (a negotiating agent in this example).

The example rules given above may be notated as set out below. In the notation, logical variables (shown as upper case single letters) are shared across a single expression and underscores represent “Don't care” variable. The parameters may range over a numerical range (such as price), an ordered set (such as quality) or an unordered set (such as colour), for example.

Thus the “I ALWAYS prefer to pay X than Y for the same contract (if X is less than Y)” may be notated as follows,

Utility ((Quantity, Failure Rate, Delivery, Price 1))<utility ((Quantity, Failure Rate, Deliver, Price 1))

IF price 1<Price 2

Similarly, the other rules may be notated as follows, “Generally I will not accept components with a failure rate greater than 0.0001”,

Utility (_, Failure Rate, _, _))=0

IF Failure Rate>0.0001

“CURRENTLY I am prepared to pay an extra 10% for next day delivery”,

Utility ((Q, F, next day, 1.1*price))=Utility ((Q,F, standard delivery, price))

“CURRENTLY the maximum I am prepared to pay per component is $2”,

Utility ((Q,_, _, P))=0

IF P>Q×$2

Constraints such as these may then be fed into a constraint programming system (which will be known to the skilled artisan) to determine if the utility function is over constrained or under constrained.

If the utility is over constrained, the constraint system may operate to identify conflicting constraints and guide the user in resolving them. A knowledge acquisition system to take the conflicting constraints and produce suitable user questions is described in the applicant's co-pending British Patent Application of even date entitled “Knowledge Acquisition Apparatus and Method”, the disclosure of which is incorporated herein by reference.

If the utility function constraints are under-constrained and no overall order can be discerned then two approaches can be used.

In the first approach, if the negotiating system is able to reason using a partial order over the space of preferred proposals then the preference map can be used without further modification.

If the negotiating system cannot accept partial orders then either further questions are asked of the user to further refine the preference map or the preference map is passed through a multi-dimensional function fitting apparatus which estimates a function across the space. Optionally, the estimated preference map or utility function may be tested by the user by generating sample questions to test the estimated space and comparing these with the answers which would be produced by the estimated space.

Thus given a preference map of the type described above, it is possible to use the preference map to reduce a multi-dimensional negotiation proposal to a scalar value (which may then be processed by a single parameter negotiating strategy in the way described in the applicant's co-pending British Patent Application of even date entitled “Automatic Contract Negotiation with Multiple Parameters”, the contents of which are incorporated by reference herein. The steps taken to map the multi-dimensional value to a single value are set out in the flow chart of FIG. 3.

With reference to the flow chart, the first steps concern the creation of the preference map.

In step 10, one or more rule is obtained from the user, for example, using a questionnaire. The rules are specified in terms of the constraints and are typically not related to particular points in the preference space.

The preference map is then built (step 12).

A multi-dimensional input is accepted (step 14). This may, for example, be a negotiation proposal specified across several dimensions such as price, delivery time, quality and/or quantity. In step 16, the position of this proposal is determined on the preference surface of the preference map. Then, by reading the value on the utility axis of the preference map (step 18) which corresponds to the position mapped on to the surface, a scalar value may be output (step 20) which provides the utility of the incoming multi-dimensional input. Thus, in the example of the negotiating proposal given above, the scalar output will be the utility of that proposal.

It will be appreciated that the preference map may also be used to “unpack” a scalar value into a multi-dimensional value. This also may be used with a negotiating method and apparatus of the form set out in the co-pending application entitled “Automatic Contract Negotiation with Multiple Parameters”. As described in that application, if the preference map produces a plurality of multi-dimensional values having the same utility value or score then it may be possible to compare incoming proposals to determine which outgoing proposal matches an incoming proposal. The steps of “inverse mapping” to unpack a scalar value into a multi-dimensional value are described below in connection with FIG. 4.

If the preference map is underconstrained, it may not be possible to provide an exact utility value for every proposal. However, given two proposals the preference map can show a preference for one of the two or indicate that it has insufficient information to perform a comparison.

With reference to the flowchart, a scalar input is accepted (step 30). This may, for example, be the output of a process of the type shown in FIG. 3.

The scalar value is then mapped (step 32) on to the preference map by finding the position or positions on the surface of the preference map with correspond to the input scalar value when read on the master or utility of the access of the preference map.

In step 34, the co-ordinates of the or each position on the surface are returned. In the case of a negotiating scenario, multiple positions on the surface correspond to respective multiple contracts which have the same utility score.

1. A multi-dimensional surface comprising at least one predetermined rule each arranged to specify a relationship between at least two of the dimensions over a predetermined range of each dimension, the rules thereby defining areas of the surface and the remainder of the surface being formed as an interpolated surface between the rule-defined areas.

2. A surface according to claim 1, wherein at least one of the rules includes a time-decaying or time-increasing function.

3. A surface according to claim 1, wherein at least one of the rules overrides any other rule which defines a mutually overlapping portion of the surface.

4. A method of mapping a multi-dimensional value to a scalar value comprising defining a surface using one or more rules which define the surface of a space in a multidimensional space, each rule defining a relationship over a range of at least one of the dimensions determining the position of the multidimensional value on the said surface by mapping the value onto the surface using the received co-ordinates of the multidimensional and returning the a scalar value which corresponds to the position of the mapped multidimensional value along a master axis of the multidimensional space.

5. A method of mapping a scalar value to a multi-dimensional value comprising defining a surface using one or more rules which define the surface of a space in a multidimensional space, each rule defining a relationship over a range of at least one of the dimensions, determining the position of the scalar value along a master axis of the multidimensional space, determining the co-ordinates of the position on the said surface which corresponds to the said position along the master axis and outputting the co-ordinates as a multidimensional mapping of the scalar value.

6. Mapping apparatus having a multi-dimensional input, a scalar output and a rule database, the rule database being arranged to contain a rule which defines a relationship between a master dimension and at least one other dimension in a multidimensional space, the relationship being defined over a range of at least one of the said dimensions, whereby the rule defines a surface in the multidimensional space, the mapping apparatus being arranged to receive a multidimensional value via the multi-dimensional input specified in terms of co-ordinate values of any of the dimensions of the rule in the rule database except the master dimension, the mapping apparatus being further arranged to map the received multidimensional value to a single value by determining where the multidimensional value lies on the surface defined by the rule, and determining the co-ordinate of this position along the axis of the master dimension, the scalar output being arranged to output the single value determined thereby.

7. Apparatus according to claim 6, wherein the or at least one of the rules includes a time-decaying or time-increasing function.

8. Apparatus according to claim 6, wherein the or at least one of the rules overrides any other rule which defines a mutually overlapping portion of the surface.

9. Mapping apparatus according to claim 6, wherein the single value output by the scalar output is a utility value.

10. Mapping apparatus according to claim 6, wherein the input co-ordinates represent respective parameters in a multi-parameter contract negotiation.

11. Apparatus according to claim 6, wherein the rule database contains a plurality of rules which define respective relationships between the master dimension and at least one other dimension in the multidimensional space, the relationships each being defined over a range of at least one of the said dimensions, whereby the rules define a plurality of surfaces in the multidimensional space, the apparatus being arranged to map the received multidimensional value by determining where the multidimensional value lies on the cumulative surface defined by the rules.

12. Apparatus according to claim 11, wherein the or at least one of the rules includes a time-decaying or time-increasing function.

13. Apparatus according to claim 11, wherein the or at least one of he rules overrides any other rule which defines a mutually overlapping portion of the surface.

14. Mapping apparatus according to claim 11, wherein the single value output by the scalar output is a utility value.

15. Mapping apparatus according to claim 11, wherein the input co-ordinates represent respective parameters in a multi-parameter contract negotiation.

16. Apparatus according to claim 7, wherein the or at least one of he rules overrides any other rule which defines a mutually overlapping portion of the surface.

17. Mapping apparatus according to claim 7, wherein the single value output by the scalar output is a utility value.

18. Mapping apparatus according to claim 7, wherein the input co-ordinates represent respective parameters in a multi-parameter contract negotiation.

19. Apparatus according to claim 8, wherein the or at least one of the rules includes a time-decaying or time-increasing function.

20. Mapping apparatus according to claim 8, wherein the single value output by the scalar output is a utility value.

21. Mapping apparatus according to claim 8, wherein the input co-ordinates represent respective parameters in a multi-parameter contract negotiation.

22. Apparatus according to claim 9, wherein the or at least one of the rules includes a time-decaying or time-increasing function.

23. Apparatus according to claim 9, wherein the or at least one of he rules overrides any other rule which defines a mutually overlapping portion of the surface.

24. Mapping apparatus according to claim 9, wherein the single value output by the scalar output is a utility value.

25. Apparatus according to claim 10, wherein the or at least one of the rules includes a time-decaying or time-increasing function.

26. Apparatus according to claim 10, wherein the or at least one of he rules overrides any other rule which defines a mutually overlapping portion of the surface.

27. Mapping apparatus according to claim 10, wherein the single value output by the scalar output is a utility value.

28. Inverse mapping apparatus having a multi-dimensional output, a scalar input and a rule database, the rule database being arranged to contain a rule which defines a relationship between a master dimension and at least one other dimension in a multidimensional space, the relationship being defined over a range of at least one of the said dimensions, whereby the rule defines a surface in the multidimensional space, the mapping apparatus being arranged to receive a single-dimensional value via the scalar input, the mapping apparatus being further arranged to map the single-dimensional value to a multidimensional value specified in terms of co-ordinate values of any of the dimensions of the rule in the rule database except the master dimension by determining where the single-dimensional value lies along the axis of the master dimension and determining the co-ordinates of the surface which corresponds to that position on the master dimension, the multi-dimensional output being arranged to output the multidimensional value determined thereby.

29. Apparatus according to claim 28, wherein the or at least one of the rules includes a time-decaying or time-increasing function.

30. Apparatus according to claim 28, wherein the or at least one of he rules overrides any other rule which defines a mutually overlapping portion of the surface.

31. Mapping apparatus according to claim 28, wherein the single value output by the scalar output is a utility value.

32. Mapping apparatus according to claim 28, wherein the input co-ordinates represent respective parameters in a multi-parameter contract negotiation.

33. Apparatus according to claim 28, wherein the rule database contains a plurality of rules which define respective relationships between the master dimension and at least one other dimension in the multidimensional space, the relationships each being defined over a range of at least one of the said dimensions, whereby the rules define a plurality of surfaces in the multidimensional space, the apparatus being arranged to map the received single-dimensional value by determining where the co-ordinates of the cumulative surface defined by the plurality of rules.

34. Apparatus according to claim 33, wherein the or at least one of the rules includes a time-decaying or time-increasing function.

35. Apparatus according to claim 33, wherein the or at least one of he rules overrides any other rule which defines a mutually overlapping portion of the surface.

36. Mapping apparatus according to claim 33, wherein the single value output by the scalar output is a utility value.

37. Mapping apparatus according to claim 33, wherein the input co-ordinates represent respective parameters in a multi-parameter contract negotiation.

38. Apparatus according to claim 29, wherein the or at least one of he rules overrides any other rule which defines a mutually overlapping portion of the surface.

39. Mapping apparatus according to claim 29, wherein the single value output by the scalar output is a utility value.

40. Mapping apparatus according to claim 29, wherein the input co-ordinates represent respective parameters in a multi-parameter contract negotiation.

41. Apparatus according to claim 30, wherein the or at least one of the rules includes a time-decaying or time-increasing function.

42. Mapping apparatus according to claim 30, wherein the single value output by the scalar output is a utility value.

43. Mapping apparatus according to claim 30, wherein the input co-ordinates represent respective parameters in a multi-parameter contract negotiation.

44. Apparatus according to claim 31, wherein the or at least one of the rules includes a time-decaying or time-increasing function.

45. Apparatus according to claim 31, wherein the or at least one of he rules overrides any other rule which defines a mutually overlapping portion of the surface.

46. Mapping apparatus according to claim 31, wherein the input co-ordinates represent respective parameters in a multi-parameter contract negotiation.

47. Apparatus according to claim 32, wherein the or at least one of the rules includes a time-decaying or time-increasing function.

48. Apparatus according to claim 32, wherein the or at least one of he rules overrides any other rule which defines a mutually overlapping portion of the surface.

49. Mapping apparatus according to claim 32, wherein the single value output by the scalar output is a utility value.
